(19) United States
(12) Patent Application Publication
(10) Pub. No.: US 2020/0400113 A1
(43) Pub. Date: Dec. 24, 2020

(54) SYSTEMS AND METHODS FOR HYDROELECTRIC SYSTEMS

(71) Applicant: DAYTON HYDRO ELECTRIC LTD., D/B/A KW RIVER HYDROELECTRIC, Hamilton, OH (US)

(72) Inventor: Paul Raymond Kling, Hamilton, OH (US)

(21) Appl. No.: 16/545,292

(22) Filed: Aug. 20, 2019

Related U.S. Application Data
(60) Provisional application No. 62/726,638, filed on Sep. 4, 2018.

(51) Int. Cl. F03B 13/08; E02B 9/00

(52) U.S. Cl. CPC F03B 13/08; F05B 2220/32; E02B 9/00

(57) ABSTRACT

Embodiments of a hydroelectric system for a dam can include a module anchored to a downstream face of the dam, the module including a protective housing that can include a Coanda-effect screen, a turbine housing retained within the protective housing, the turbine housing including an upper inlet portion at a first end, a substantially tubular portion, and a lower outlet portion at a second end, the upper inlet portion being positioned above the lower outlet portion, a turbine retained at least partially within the turbine housing, the turbine including a plurality of blades coupled with a central shaft, and a fluid pump, the fluid pump being coupled with the central shaft, where the fluid pump is configured to pump a high pressure fluid, a fluid circuit, the fluid circuit including piping, where the high pressure fluid is retained within the piping, and a generator, the generator being coupled with the fluid circuit, where the generator is driven by the high pressure fluid that is pumped by the fluid pump in response to the rotation of the turbine.

### TECHNICAL FIELD

Embodiments of the technology relate, in general, to hydroelectric technology, and in particular to hydroelectric systems that can be used to generate power from low dams and other fluid sources.

### BRIEF DESCRIPTION OF THE DRAWINGS

The present disclosure will be more readily understood from a detailed description of some example embodiments taken in conjunction with the following figures:

FIG. 1 depicts a perspective view of a hydroelectric generator module according to one embodiment.

FIG. 2 depicts a perspective partially exploded view of the hydroelectric generator module depicted in FIG. 1.

FIG. 3 depicts a left side cross-sectional view of the hydroelectric generator module depicted in FIG. 1 shown adjacent a low head dam according to one embodiment.

FIG. 4 depicts a perspective view of a pump module according to one embodiment.

FIG. 5 depicts a perspective view of a system of interconnected pump modules shown associated with a land-based generator.

FIG. 6 depicts a perspective view of a system of pump modules of FIG. 4 shown interconnected in series.

FIG. 7 depicts a side view of a hydroelectric generator module shown mounted on the downstream face of a dam.

FIG. 8 depicts a perspective view of a hydroelectric generator module shown mounted on the downstream face of a dam.

FIG. 9 depicts a side schematic view of a wedge wire screen.

FIG. 10 depicts a perspective view of a screen having parallel rods oriented in a flow direction.

FIG. 11 depicts a perspective view of a hydroelectric generator module shown mounted on the downstream face of a dam.

### BACKGROUND

Renewable energy resources are gaining global attention due to depleting fossil fuels and harmful environmental effects associated with their usage. Hydro, wind, solar, biomass and geothermal energies form the bulk of renewable energy sources; among which hydro power may offer one of the more sustainable propositions. Traditionally, hydro power has accounted for the bulk of the renewable energy production in the United States. Low dams, also sometimes called low-head dams or weirs, are vertically oriented short dams that can be placed in water channels. Low dams can be used to maintain a minimum water depth for water supply to a municipality or for flood control purposes. The reservoir-pool of water created by low dam is often used to supply cooling water for industrial applications. Low dams have also been constructed to raise the water level to a sufficient height to support recreational boating and are in some cases referred to a Lake Dams.

### SUMMARY

Embodiments of a hydroelectric system for a dam, including a low head dam can include a module including a protective housing that can include a Coanda-effect screen, a turbine housing retained within the protective housing, the turbine housing including an upper inlet portion at a first end, a substantially tubular portion, and a lower outlet portion at a second end, the upper inlet portion being positioned above the lower outlet portion, a turbine retained at least partially within the turbine housing, the turbine including a plurality of blades coupled with a central shaft, and a fluid pump, the fluid pump being coupled with the central shaft, where the fluid pump is configured to pump a high pressure fluid, a fluid circuit, the fluid circuit including piping, where the high pressure fluid is retained within the piping, and a shoreline generator, the shoreline generator being coupled with the fluid circuit, where the offsite generator is driven by the high pressure fluid that is pumped by the fluid pump in response to the rotation of the turbine.

Embodiments of a method for operating a hydroelectric system can include providing a hydroelectric system, where the hydroelectric system can include a module having a protective housing anchored to a downstream face of a dam, a turbine housing retained within the protective housing, the turbine housing including an upper inlet portion at a first end, a substantially tubular portion, and a lower outlet portion at a second end, the upper inlet portion being positioned above the lower outlet portion, a turbine retained at least partially within the turbine housing, the turbine including a plurality of blades coupled with a central shaft, and a fluid pump, the fluid pump being coupled with the central shaft, where the fluid pump is configured to pump a high pressure fluid, a fluid circuit, the fluid circuit including piping, where the high pressure fluid is retained within the piping, and a shoreline generator, the shoreline generator being coupled with the fluid circuit, where the shoreline generator is driven by the high pressure fluid that is pumped by the fluid pump in response to the rotation of the turbine. The method can include positioning the module adjacent a low head dam, where a fluid is flowing over the low head dam, rotating the turbine with the fluid flowing over the low dam, pumping the high pressure fluid with the fluid pump in response to the rotation of the turbine, and driving the shoreline generator with the high pressure fluid to produce electricity.

Embodiments of a hydroelectric system for a dam, including a low head dam, can include a module that can be anchored to a downstream face of a dam, the module including a housing means retained within the protective means, a turbine means retained at least partially within the housing means, and a pump means operatively coupled with the turbine means, where the pump means is configured to pump a high pressure fluid, a fluid circuit associated with the pump means, and a generator means coupled with the fluid circuit.

### DETAILED DESCRIPTION

Various non-limiting embodiments of the present disclosure will now be described to provide an overall understanding of the principles of the structure, function, and use of the apparatuses, systems, methods, and processes disclosed herein. One or more examples of these non-limiting embodiments are illustrated in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment,” or “in an embodiment” in places throughout the specification are not necessarily all referring to the same embodiment. Furthermore, the particular features, structures or characteristics may be combined in any suitable manner in one or more embodiments.

Described herein are example embodiments of apparatuses, systems, and methods for hydroelectric power generation. In some embodiments, a hydroelectric power generator that can be deployed at dams having a generally flat downstream face is disclosed. In example embodiments, a hydroelectric power generator that can be deployed at low dams is disclosed. In some embodiments, the hydroelectric generator can produce power from both the pressure differential created by a low dam as well as the flow velocity of the water channel. In some embodiments, the hydroelectric generator can be self-contained in a submersible module which can further be a hydraulic-hydrokinetic power production module (“HPPM”). In some embodiments, a system of hydroelectric generator systems or HPPMs can be deployed in a water channel to capture a larger amount of energy from the channel than one generator module can capture. In some embodiments, the hydroelectric generator module can generate electricity during the lowest flow-rate condition of a water source. In certain embodiments, the system can include a hydroelectric generator that can efficiently generate power at low dams without ecologically destabilizing a water channel or requiring expensive installation.

The examples discussed herein are examples only and are provided to assist in the explanation of the apparatuses, devices, systems and methods described herein. None of the features or components shown in the drawings or discussed below should be taken as mandatory for any specific implementation of any of these the apparatuses, devices, systems or methods unless specifically designated as mandatory. For ease of reading and clarity, certain components, modules, or methods may be described solely in connection with a specific figure. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Example embodiments described herein can beneficially capture energy from water channels during all flow conditions of the channel and can operate without detrimental effect to the water channel's ecology or environment. For example, the flow rate, appearance, and usability of the water channel by boats and wildlife can remain unaffected or substantially unaffected by operation of the generator modules or pump modules described herein. Traditional hydroelectric generators, in contrast, can cause fish kill due to the high speed at which their turbines operate. Additionally, the present hydroelectric generators modules and pump modules can be easily installed with common equipment. The generators and modules can also be installed in such a way that they do not interfere or compromise the purpose of a dam, including a low dam. Such a configuration can generate pollution-free electricity. The installation of HPPMs on the downstream side of an existing low dam may have no more of an environmental effect than that of the low dam itself. The hydraulic boils created at the foot of low dams are notorious for entrapping canoers, kayakers, and small boats. Embodiments described herein can mitigate and minimize the hydraulic boils such that low head dam safety improvements can be provided.

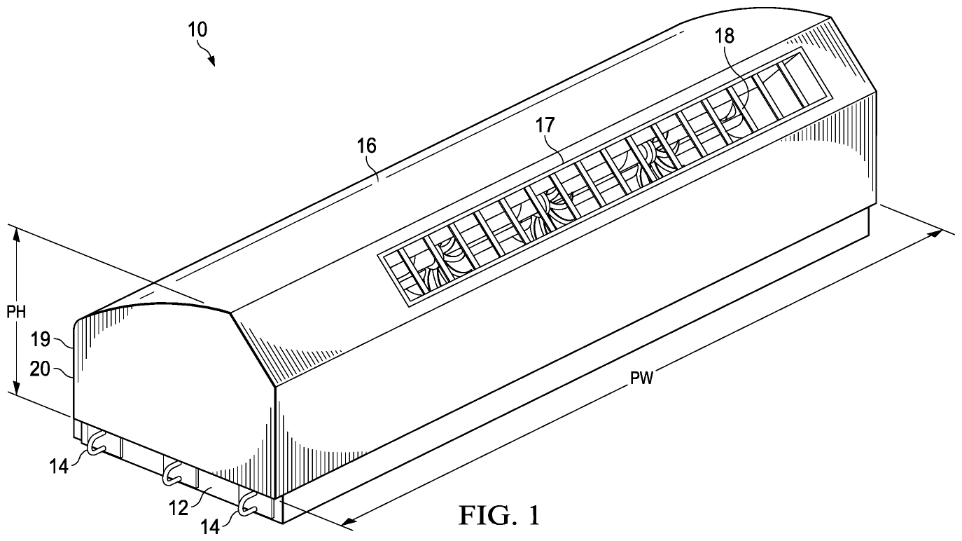

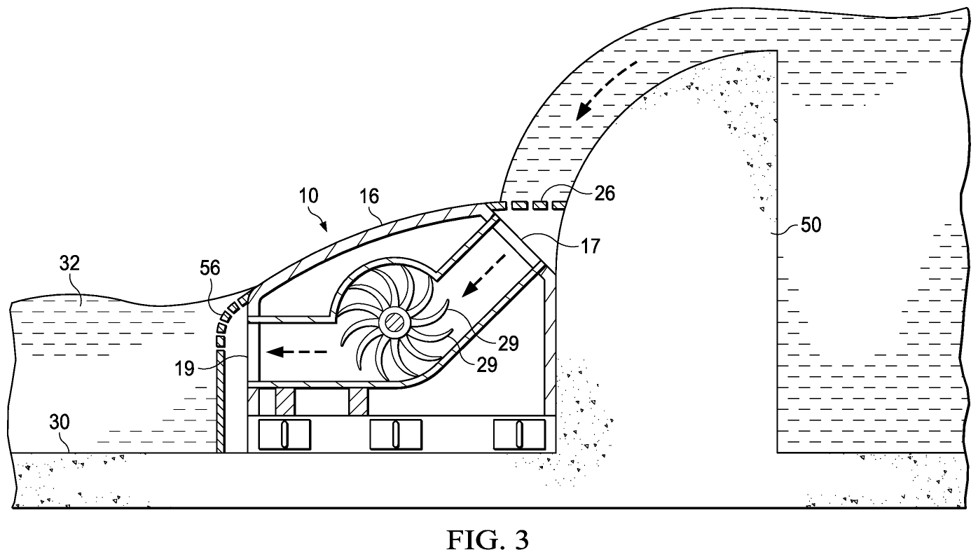

Referring now to FIG. 1, a hydroelectric generator module 10 is depicted according to one embodiment. The generator module 10 can be water submersible and can be attached to, or adjacent to, a low dam 50 (FIG. 3). The generator module 10 can be located on a platform 12, such as a concrete platform, for support. The platform 12 can also assist in installation of the generator module 10. For example, the platform 12 can include mounting points 14 that can assist in installation or removal of the generator module 10 by common moving equipment. In some examples, the platform 12 can additionally, or in the alternative, include shaped cavities (not shown) along a bottom surface to allow the generator module to be transported by a forklift or other suitable vehicle. The mounting points 14 can include hooks, rings, or any other suitable coupling or connection. The generator modules can be designed for easy placement and removal or, alternatively, the generator modules can be permanently affixed or integrally coupled with a low head dam. Any suitable anchoring method is contemplated such as bolted, weighted, wedged, cemented, hinged, or welded anchoring mechanisms, for example.

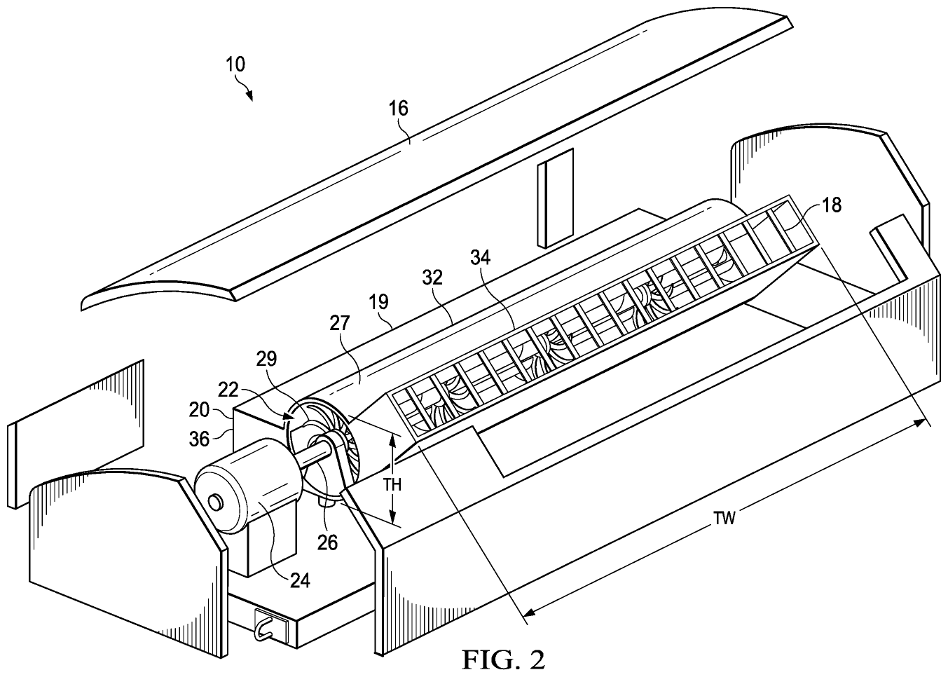

The generator module 10 can have a protective enclosure 16 that can protect internal components as well as wildlife and recreational users of waterways. The protective cover 16 can be configured to make the generator module 10 look like a part of the low dam 50 to provide an aesthetically pleasing appearance. In one example, the protective enclosure 16 can be concrete. In another example, the protective enclosure 16 can be metal. In another example, the protective enclosure 16 can be a non-metallic composite material. The protective enclosure 16 can include a first opening 17 protected by an upstream grate 18 and a second opening 19 protected by a downstream grate 20 that can prevent debris from damaging the turbine and generator located inside. The first opening 17 can allow head water from the water channel to flow through the generator module 10 to produce electricity. Head water can exit the generator module 10 through the second opening 19 after flowing through the internal turbine 22 (FIG. 2). The first opening 17 can be positioned above the second opening 19 to match the direction flow of fluid over the low head dam as illustrated in FIG. 3. The first opening 17 and second opening 19 can have the same dimensions or can be configured differently. The first opening 17 and second opening 19 can have a width of from about 1 inch to about 2 inches in one embodiment. The first opening 17 can have a funnel shape or any other suitable shape for directing water into the module 10.

Any suitable protective housing 16 is contemplated. The protective housing 16 can substantially surround the turbine housing 27 (FIG. 2) and can provide debris protection, increase operational safety, enhance aesthetics, improve flow characteristics, and efficiency of the generator module 10. The protective housing 16 can be mass produced, or can be designed to substantially match the flow characteristics of a particular waterway. The protective housing 16 can improve protection of various aquatic biology and can prevent damage of the turbine that can be caused by such aquatic biology. The protective housing 16 can be metallic, aluminum plate, light weight, and low corrosion. The protective housing 16 can be steel plate that is cost effective and machinable. The protective housing 16 can be formed from metallic castings that are cost effective and reproducible at high production volumes. The protective housing can include non-metallic, biologically inert materials that may improve environmental compatibility. Such materials can include recycled plastic, which may have the advantage of being low cost and environmentally friendly. Materials can include HDPE, XLPE, or other readily available, low cost materials with well-known properties. The protective housing 16 can include composite materials such as carbon fiber, which may have enhanced operational and component forming properties. Housing coatings (not shown) may provide additional debris protection, increase operational safety, enhance aesthetics, improve flow characteristics and efficiency, slow deterioration, and/or improve the protection of aquatic biology. The protective housing 16 coatings can include cementacious materials, which are generally inexpensive and can provide additional durability, carbon nanotube materials, which can prevent adherence of biologic material, and epoxies, resins, or enamels, which can add additional strength and corrosion resistance.

The protective housing 16 can have a protective housing height PH and a protective housing width PW as depicted in FIG. 1. The actual points of measurement or exact dimensions can vary based on the protective housing 16 shape. In general, however, the protective housing width PW can be a dimension measured perpendicular to the flow of water over a dam, and the protective housing height PH can be a dimension measured perpendicular to the anchoring surface on which the protective housing 16 is anchored on a dam 50. In general, the housing width PW of protective housing 16 can be greater than the protective housing height PH.

FIG. 2 depicts a partially exploded view of a generator module 10 according to one embodiment with the protective enclosure 16 removed. The generator module 10 can include a turbine 22 and a generator 24. The turbine 22 can be operationally similar to a water wheel and can be an impulse turbine such as a cross-flow turbine. Turbine 22 can include any number of blades 29 that can project radially outward from a central shaft 26. In an embodiment the turbine 22 In one example, the turbine 22 can include between about six and fifty blades. In another example, a turbine 22 can include between about nine and thirty blades. In another example, a turbine 22 can include twelve, twenty, or more blades. The generator 24 can be a variable capacity generator that can operate over a range of water flow velocities. The generator 24 can be directly coupled to the central shaft 26 of the turbine 22 or the generator 24 can alternatively be connected to an intermediary gearbox (not shown). The turbine 22 and generator 24 can operate at relatively slow speeds to prevent damage to the ecosystem. For example, the turbine can operate at from about 20 to about 100 RPM, from about 30 to about 60 RPM, at less than about 50 RPM, at 60 RPM, or at less than about 120 RPM. The relatively low speed can also prevent the generator module 10 from causing fish kill. The overall efficiency of the generator module can be at least about 70%, at least about 75%, at least about 80%, at least about 85%, or at least about 90%. The turbine and generator can be coupled directly to the platform 12 for stability, or can be coupled with the protective enclosure 16 that can be selectively removable from a fixed platform 12.

The generator module 10 can have any suitable structure for a central shaft 26. The central shaft 26 can be designed in sections from about 4 feet to about 10 feet in length, for example, along the shaft axis allowing each section to be constructed with the turbine blades 29 as a module and aligned and fitted in a turbine housing 27 with a turbine housing height TH that is a dimension sufficient to provide clearance for turbine blades 29 and fit without protective housing 16 taking into account the thickness of the material of the turbine housing. The turbine housing 16 can also have a turbine housing width TW that can range from about 6 feet to about 60 feet, for example. In an embodiment the turbine housing 27 is at least partially tubular about an outer surface, as depicted in FIGS. 2 and 3, and turbine housing height TH can be considered the diameter of the tubular portion in cross section. The central shaft 26 can be constructed of solid, tubular, or semi-solid metallic, non-metallic, or composite material. The central shaft 26 can be formed, cast, machined, extruded, or configured using any combination of these manufacturing methods. Adjacent axial shafts can be connected by any number of methods including, but not limited to, bolted flanges, flexible or mechanical couplings, welded joints, sleeve and key, or any combination of these mechanisms. Turbine shaft bearings (not shown) can be configured in any suitable manner from any suitable material such as utilizing specialized wood (Lignum Vitae) bearings, sealed steel roller or ball bearings, full contact malleable metallic materials, or full contact malleable non-metallic materials. A small space or cutout (not shown) between the blades and shaft of the turbine can be provided to minimize the presence and effect of air entrainment.

The turbine 22 can be housed within the turbine housing 27, which can include a substantially tubular portion 32, an upper inlet portion 34, and a lower outlet portion 36. The substantially tubular portion 32 can be sized to accommodate any suitable turbine 22. It will be appreciated that the tubular portion 32 is described by way of example only, where any suitable shape is contemplated. The upper inlet portion 34 can include the upstream grate 18 and the lower inlet portion 36 can include the downstream grate 20. The upper inlet portion 34 can have any suitable size, shape, or configuration to direct the flow of fluid through the turbine housing 27 past the turbine 22. The upper inlet portion 34 can be substantially the length of the generator module 10, can be shorter than the length of the generator module 10, or can be wider or longer than the generator module 10 with a funnel (not shown) or other mechanism for drawing fluid into the turbine housing 27. The turbine housing 27 can include a plurality of upper inlet portions and a plurality of lower outlet portions having any suitable shape or configuration. In one embodiment, generator module 10 can have a flexible or pivotable protective enclosure 16 and/or turbine housing 27 such that the turbine housing 27 and/or protective enclosure 16 can be adjusted relative to the flow of water over the dam 50. For example, the turbine housing 27 can be a pivoting housing relative to the platform 12 to enable the upper inlet portion 34 to the turbine 22 to be at an optimal angle relative to the adjacent dam 50 and the flow of water. The adjustable or pivotable structure can be mechanically adjusted or, in one embodiment, can be associated with a controller that can automatically adjust the position of the structure based upon water flow, environmental conditions, or the like.

FIG. 3 depicts a side cross-sectional view of a generator module 10 and low dam 50 according to one embodiment. The generator module 10 can be installed on the low dam 50 such that it can collect substantially all of the water flowing over the low dam 50. Installation in this manner can allow the generator module 10 to appear as if it is part of the low dam 50. In some examples, a protective screen 26 can be attached to the generator module at about the first opening 17 and/or at about the second opening 19. The protective screen can extend from the generator module 10 and connect an area upstream, i.e., above the first opening 17 to the low dam 50. The protective screen 26 can extend from above the second opening 19 to the floor 30 of the water channel 32. The protective screen 26 materials can prevent small debris from flowing into the generator module and causing damage. In other examples, a single screen can extend from the low dam 50 to the water channel floor 30 as a substantially contiguous cover to achieve substantially the same effect. The protective screen 26 can be fabricated from biologically inert material, wear resistant material, can be design to withstand flood-stage debris impingement, and/or can be used in conjunction with a back-flow screen or great cleaning system.

Turbine blades 29 can be fabricated from any number of different materials using any number of machining or forming processes. In each case, a mathematical formula based on anticipated flow rate at the specific installation site can be used to determine the optimal blade shape and size as well as the number of blades comprising the turbine 22 for maximum efficiency versus production costs, installation costs, and full life-cycle costs. Blade curvature and number of blades can be mathematically optimized using the blade element momentum (BEM) theory, for example, over the anticipated flow range for maximum power transfer efficiency and acceptable life cycle economic costs. The BEM theory is described in more detail in Hydrodynamic Design and Optimization of Hydro-Kinetic Turbines using a Robust Design Method, by Nitin Kolekar, et al., Proceedings of the 1st Marine Energy Technology Symposium, Apr. 10-11, 2013, Washington, D.C., which is herein incorporated by reference in its entirety. Factors such as number of blades, tip speed ratio, type of airfoil, blade pitch, and chord length and twist can be considered. Flow range can be considered for maximum power transfer efficiency and acceptable life cycle economic costs. Blades 29 can include metallic blades, such as aluminum blades, which can be plates, formed blades, cast blades, machined blades, bent blades, extruded blades, or the like, where such aluminum blades may be readily machineable and cost effective. Steel blades can be used that have high strength, low cost, and manufacturing familiarity. Brass or bronze blades can be used that can exhibit corrosion resistance. Non-metallic blades, such as carbon fiber composite and ceramic blades, can exhibit wear resistance and low life cycle costs. Plastics may have a low cost, high availability, and may be biologically inert, and can include HDPE, XLPE, recycled plastic, and laminates, singularly or in combination. It will be appreciated that any suitable combination of materials including wood, resins, plastics, metallic, and/or ceramic is contemplated.

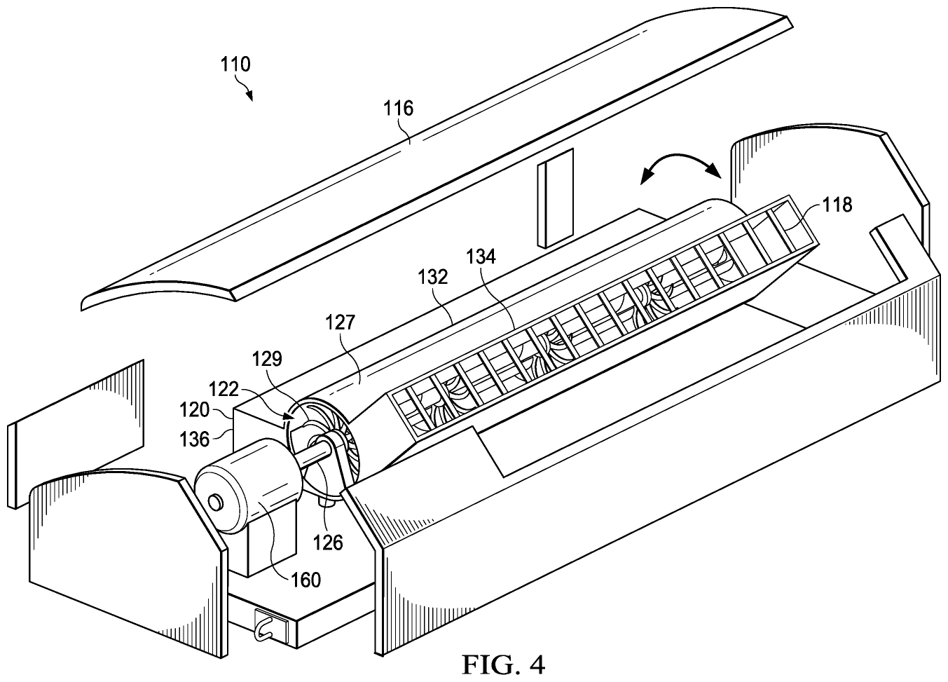

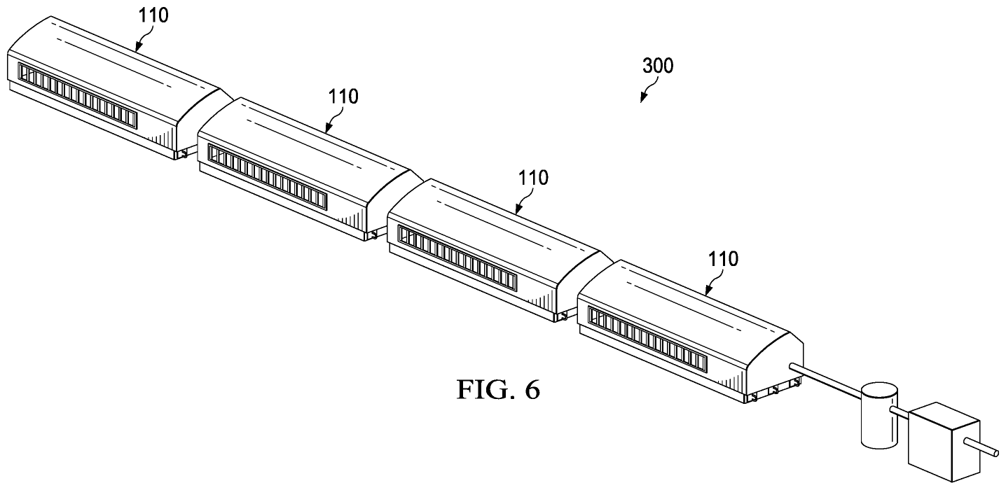

Referring to FIG. 4, an alternate embodiment of a module 110 is shown. The module 110 can include a protective enclosure 116, a turbine 122, and instead of or in addition to a generator (not shown in FIG. 4), a fluid pump 160. As discussed above, the turbine 122 can include any number of blades 129 that can project radially outward from a central shaft 126. The fluid pump 160 can be used to pump high pressure fluids, such as biodegradable, biologically inert, or non-compressible fluids, or combinations thereof, from the module 110 to a generator 124 (FIG. 6) positioned on the shoreline or at a distance from the module 110. The turbine 122 can be housed within a turbine housing 127 that can have a substantially tubular portion 132, an upper inlet portion 134, and a lower outlet portion 136. The substantially tubular portion 132 can be sized to accommodate any suitable turbine 122. The upper inlet portion 134 can include an upstream grate 118 and the lower inlet portion 136 can include the downstream grate 120. The module 110 configuration can include the central shaft 126 being connected to the fluid pump 160. Systems can be configured for screen or grate cleaning systems and can be back flushed with water and/or back flushed with air. It will be appreciated that the module 110 can also include or be attached to a water submersible electric generator.

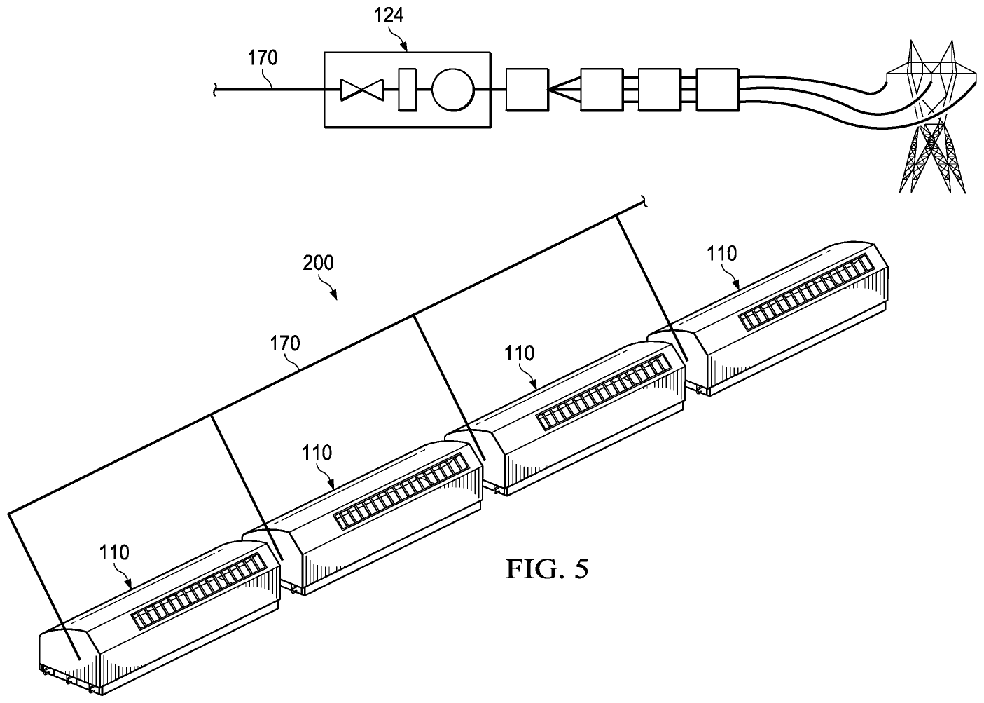

Referring to FIG. 5, a plurality of modules 110 can be coupled into a pressurized fluid system 200. In the illustrated system 200, the fluid pumps 160 from each of the modules 110 can form a plurality of circuits 170, where each fluid pump 160 can be connected to a header body. Fluid from the system 200 can be used to generate electricity from an offsite or shore-based generator 124 or turbine. The system 200 can include a single turbine powered pump system, a multiple pump system with combined header system, and can utilize any suitable flexible or rigid tubing or piping in any suitable configuration. In an example embodiment, the system 200 can include one or a plurality of pressure and/or flow regulators that can maintain a substantially constant rate of flow and/or pressure to a shore-based generator or turbine. The pressure and/or flow regulator can include ball valves, or the like, having any suitable dimensions and can include a variety of different sized ball valves. The one or a plurality of fluid pumps associated with the system 200 can pump fluid to a remote generator incorporating an internal inverter, a generator having a separate inverter, or is a pressure and/or fluid regular is used no inverter may be required. The circuits 170 can include any suitable fittings, tubing, connectors, or the like. In one embodiment, the system can incorporate a pre-configured IEEE 1547 standard (Institute of Electrical and Electronics Engineers, Standard 1547) compliment of components for grid connection. An electrical interconnection configuration can include frequency feedback from a grid, can be designed without frequency from a grid, or can be configured or optimized for micro-grid applications.

FIG. 6 illustrates a system 300 having a plurality of modules 110 in series according to one embodiment. It will be appreciated that any suitable number, size, placement, and spacing of modules 110 is contemplated.

Systems described herein can generate a certain minimum amount of power even in low flow rate conditions. In addition to installation on a low dam 50, a generator module 10 or pump module 110 can alternatively be installed in a water channel. In one embodiment, a generator module 10 or module 110, in this example, can still generate electricity from the flow rate of the water channel as a result of the low-speed efficiency of the turbine. The generator module 10 or module 110 can operate, for example, in any water channel that has a continuous or substantially continuous flow rate such as, for example, a river, stream, creek, or waste water treatment facility exit trough. Such a system can be useful to establish a minimum level of power production. This can be advantageous for the present system because renewable power sources are traditionally subject to a wide variability in minimum generation which can necessitate that utility companies maintain a large reserve of generating capacity. For example, a utility company that operates a wind farm may have to maintain a coal plant in ready status in case the wind farm becomes inoperable due to falling wind speeds. Power generated through the systems depicted herein may negate this issue by providing a base amount of power.

In one embodiment, a generator module or pump module, such as generator module 10 or module 110, can continue to generate electricity up to and during the infrequent period when tail water converges to the same level as head water, or zero head. Flow volume can continue to descend the crest of the dam during this period and this kinetic energy can be sufficient to generate appreciable amounts of electricity. Conventional pressure-driven hydroelectric designs may not generate any electricity during this period, which may minimize their overall efficiency and effectiveness.

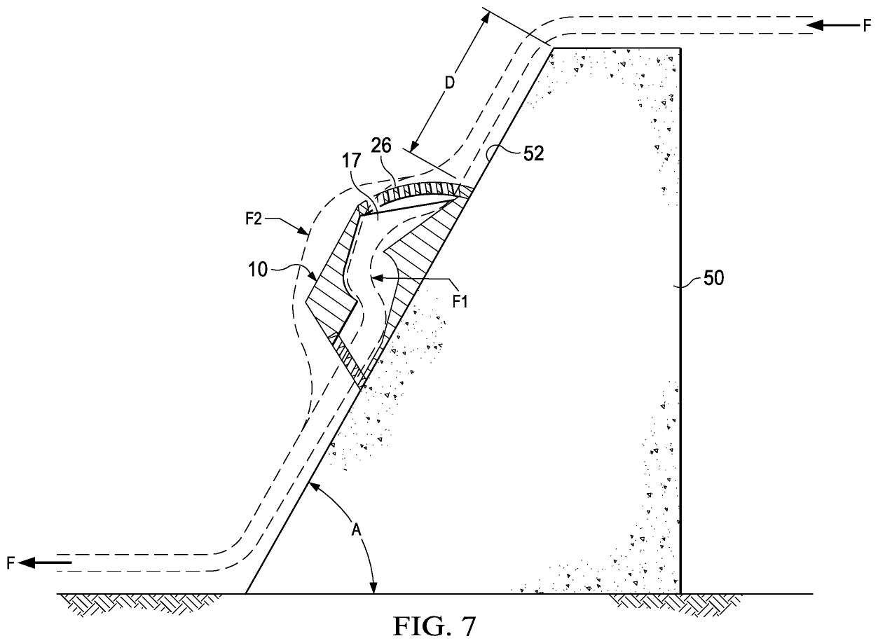

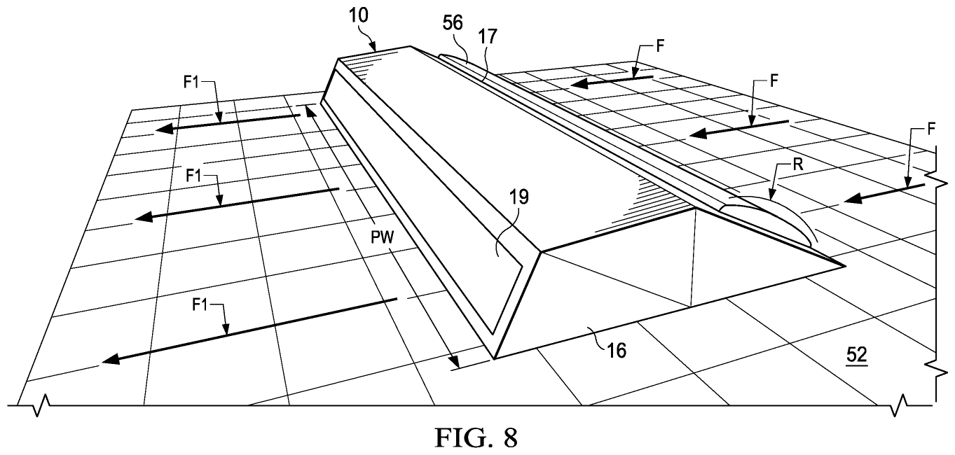

In an embodiment, a generator module 10 or module 110 as described above can be mounted operationally on the downstream face of a dam, rather than at the base of a dam, as depicted in FIG. 3. When mounted to an inclined face of a dam the dam need not be a low dam 50. Referring now to FIG. 7, there is shown a generator module 10 (or module 110, but for simplicity herein the description may refer only to module 10) as described above anchored to the downstream face 52 of a representative dam 50. Dam 50 can be any height and any width greater than the protective housing width PW of the generator module 10, as depicted in FIG. 8. The downstream face 52 can be generally flat and can be angled from level ground (or at the water level at the top of the dam) at an angle A of at least 10 degrees. In an embodiment, angle A can be from about 10 degrees to about 90 degrees, and it can be greater than 45 degrees, greater than 60 degrees or greater than 80 degrees.

Water flow F flows by gravity over the top of dam 50 and is directed down the face 52 of dam 50. The water flowing down the face 52 of dam 50 can impinge the upstream first opening 17 of generator module 10, with a first portion of water flow F1 entering the protective screen 26 (if utilized) and drive the turbine (not shown) of generator module 10, as described above. Some of the flow, including debris-laden water, fish, and other solids, can flow over and around generator module 10 in a second portion of water flow F2. Water flow portions F1 and F2 continue downstream once past generator module 10. In an embodiment, generator module 10 is located a distance D from the top of dam 50. Distance D can be any distance over which the water flowing over dam 50 has sufficient velocity to drive the turbine for the desired power output, referred to as a head distance. In general, distance D can be at least two feet from the top of dam 50, and can be any distance less than the length of downstream face 52 parallel to the water flow.

In an embodiment, a generator module 10 or module 110 as described above can have increased power production at the turbine when provided at the first opening 17 with an inlet screen 26 that takes advantage of the Coanda effect. Coanda effect is the phenomena in which a fluid flow attaches itself to a nearby surface and remains attached even when the surface curves away from the initial flow direction. In an embodiment, a generator module 10 or module 110 can also, or optionally, take advantage of a Tyrolean screen. A Tyrolean screen can consist of either parallel rods or a perforated plate, installed parallel to the flow direction over at least a portion of the protective housing width PW of the flow F into a generator module 10 (or module 110). In an embodiment, a generator module 10 can incorporate Coanda effect screens and Tyrolean screens. In an embodiment, water flow F flows through a Tyrolean screen having rod materials, dimensions and spacing appropriate for the location, and then the water that clears the Tyrolean screen can flow to a Coanda effect screen for further flow separation prior to a portion of the flow F1 driving the turbine 22.

As depicted in FIG. 8, generator module 10 can have a protective screen 26 that can be a wedge-wire Coanda-effect screen or a Tyrolean screen. Representative screen designs include those available, for example, from Hydroscreen Co. LLC of Denver Colo., Elgin Separation Solutions of Elgin, Ill., or Gap Technology, Nottinghamshire, UK. Protective screens can be made from stainless steel or any other suitable metallic material. Protective screens can also comprise non-metallic materials such as polymeric materials, composite materials, and combinations thereof for environmental compatibility purposes or to mitigate ice formation. In an embodiment, the non-metallic material can be High Density Polyethylene (HDPE).

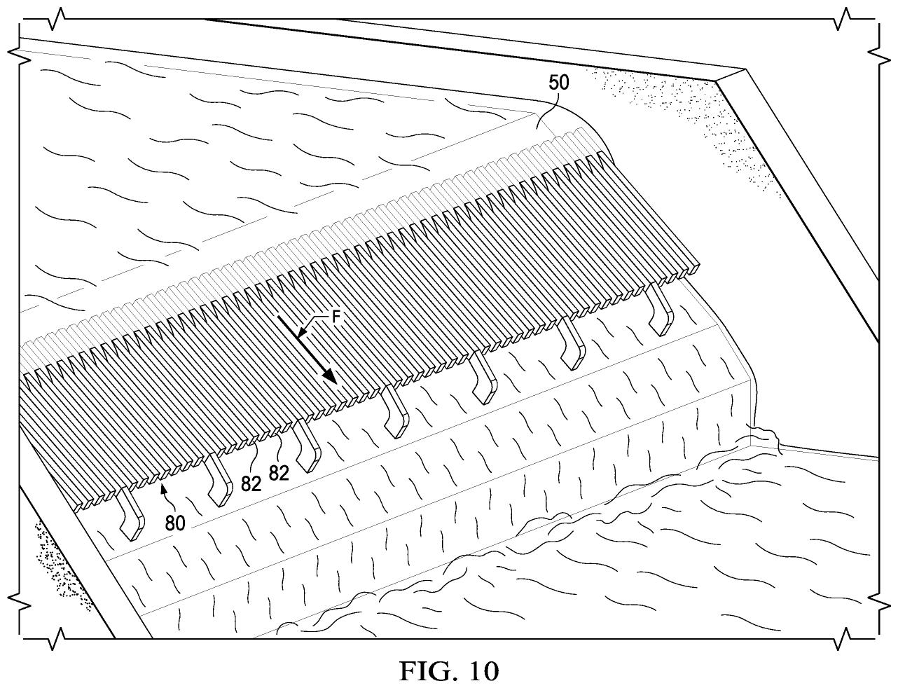

In addition to potentially significantly increasing the fluid flow into the turbine 22, a wedge-wire Coanda-effect screen or Tyrolean screen can be generally self-cleaning and can provide a filter for preventing fish and debris from entering turbine 22. Wedge-wire Coanda-effect screens take advantage of the Coanda effect by utilizing individually wedge-shape (in cross-section) wires oriented relative to the fluid flow F so as to enhance redirection of flow F to first flow F1 into and through turbine 22. Such wedge-shape wires are depicted schematically in FIG. 10 which also shows a representative fluid flow across a wedge-wire Coanda-effect screen 56. The individual wedge wires 58 are oriented perpendicular to the fluid flow F tilted along their axes (axes extend into the image as shown in FIG. 10) so that the leading edge 60 of each wire projects into the flow F, causing the screen 56 to shear a thin layer of the flow from the bottom of the water at each slot opening, which flow becomes flow F1 as described above. Flow not sheared off and directed to turbine 22 continues as flow F2 as described above. The wedge wires also take advantage of the Venturi Effect as water passes through the downstream expansion of the spaces between the wires. This effect creates a low pressure zone on the downstream side of the wires that further draws additional water from the flow of water at the upstream side of the screen.

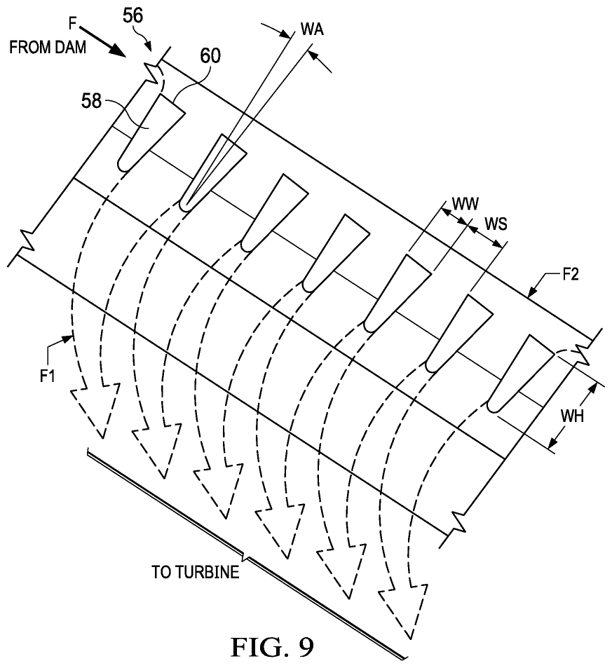

Wedge wires 58 can be arranged in regular, parallel, spaced relationship, with each wedge wire 58 having a wire width WW measured at the “top” of the wedge and a wire height WH measured from the top to the trailing edge “point” as depicted in FIG. 9. Wire width WW can be from about from about 1 mm to about 10 mm. Wire height can be from about 2 to about 16 mm. The wedge wires 58 can be separated by a wedge wire spacing WS, measured between wedge wires at the top of the wedge, which can be from about 0.5 mm to about 5 mm. The wire width WW and wire spacing WS can determine an open area through which flow F1 can pass, with open area being from about 20% to about 70%. Each wedge wire can be oriented at a “tilt” or wedge wire angle WA such that the top surface of the wedge is oriented an angle relative to the flow of water F impinging the wedge wire screen 56 from the dam overflow.

In general, the Coanda effect causes flow to remain attached to the top surface of each wire, thus enhancing the shearing action that directs water to flow F1 into turbine 22. The enhanced shearing can be controlled according to predetermined design criteria by modifying any or all of the wedge angle (i.e., the angle to the trailing edge “point” of the wedge wire in cross section), the tilt angle WA, wedge wire width WW, and wedge wire spacing WS.

A Coanda-effect screen 56 can be affixed to first opening 17 so that relatively closely spaced and angled wedge-wires direct water from flow F into first opening 17 as flow F1, while filtering, so to speak, debris, fish, and other solids out of first opening 17, being redirected over generator module as flow F2. A Coanda-effect screen 56 can be affixed to first opening 17 on a generator module 10 or module 110 anchored either the base of a dam as shown in FIG. 3, or the face 52 of a dam as shown in FIG. 8.

Further, in accordance with principles of the Coanda-effect, the Coanda-effect screen 56 can have an overall curvature perpendicular to the flow F from dam 50 that can enhance flow F1 into and through turbines 22. As shown in FIG. 8, for example, Coanda-effect screen 56 (or Tyrolean screen) can have a concave (relative to generator module 10) radius of curvature R. The radius of curvature R can be predetermined according to the angle A of dam face 52, such that flow F impinging on Coanda-effect screen 56 can cause the flow F to remain in contact with screen 56 as it flows downstream. This lengthening of the time and distance that flow F in in contact with screen 56 also results in more flow F in contact with wedge wires 58, which can result in further enhanced flow F1 into and through turbines 22.

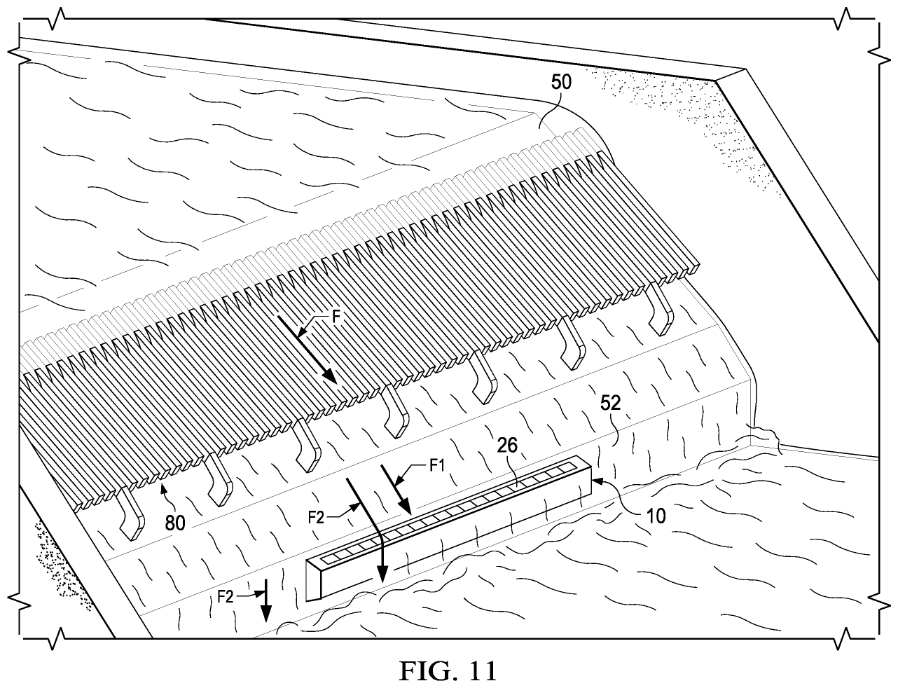

In an embodiment, as depicted in FIG. 10, a screen 80 can comprise bars 82 and/or wedge wires mounted on, over, or before screen 56 parallel to flow F in what can is referred to herein as a Tyrolean orientation. In FIG. 11, a generator module 10 with or without a Coanda effect screen 56 can be mounted under the Tyrolean screen 80, receiving flow F that passes through screen 80. Bars 82, including wedge wires, can be an extruded bar design to withstand greater debris impingement forces. Being oriented parallel to flow F can create a low pressure zone due to the Venturi Effect as water passes through the spacing between the bars that further draws additional water from flow F to flow F1 into and through turbine 22.

As depicted in FIG. 12, generator module 10 (or module 110) can have a protective screen 26 that can be a wedge-wire Coanda-effect screen 56 and can be mounted on a dam 50 face 52 downstream of a Tyrolean screen 80. As shown, flow F can pass through a Tyrolean screen 80 before reaching protective screen 26, which can be a Coanda-effect screen 56, as flow F1 through turbine 22.

The foregoing description of embodiments and examples has been presented for purposes of illustration and description. It is not intended to be exhaustive or limiting to the forms described. Numerous modifications are possible in light of the above teachings. Some of those modifications have been discussed, and others will be understood by those skilled in the art. The embodiments were chosen and described in order to best illustrate principles of various embodiments as are suited to particular uses contemplated. The scope is, of course, not limited to the examples set forth herein, but can be employed in any number of applications and equivalent devices by those of ordinary skill in the art. Rather it is hereby intended the scope of the invention to be defined by the claims appended hereto.

We claim:

1. A hydroelectric system comprising:
(a) a dam, the dam having a downstream face and a top surface over which a flow of water flows to the downstream face;
(b) a module anchored to the downstream face of the dam for receiving a first portion of the flow of water, the module including;
(i) a protective housing having a first height and a first width, wherein the first width of the protective housing is greater than the first height of the protective housing;
(ii) a turbine housing retained within the protective housing, the turbine housing having a second height and a second width, wherein the second width of the turbine housing is greater than the second height of the turbine housing;
(iii) a turbine retained at least partially within the turbine housing, the turbine including a plurality of blades coupled with a substantially horizontal central shaft, wherein the substantially horizontal central shaft of the turbine has an axis of rotation that is substantially perpendicular to the fluid flow direction during operation; and
(iv) a fluid pump, the fluid pump being coupled with the substantially horizontal central shaft, wherein the fluid pump is configured to pump a high pressure fluid;
(c) a fluid circuit, the fluid circuit including piping, wherein the high pressure fluid is retained within the piping; and
(d) a generator, the generator being spaced apart a distance from the module and operably coupled with the fluid circuit, wherein the generator is driven by the high pressure fluid that is pumped by the fluid pump in response to the rotation of the turbine.

2. The hydroelectric system of claim 1, wherein the high pressure fluid is selected from the group consisting of biodegradable fluid, biologically inert fluid, and non-compressible fluid.

3. The hydroelectric system of claim 1, wherein the module further includes a protective mesh.

4. The hydroelectric system of claim 1, further comprising an upstream screen associated with the protective housing, the upstream screen being a Coanda-effect screen.

5. The hydroelectric system of claim 1, wherein the turbine housing is pivotable relative to the protective housing.

6. The hydroelectric system of claim 1, wherein the turbine comprises from six to fifty blades.

7. The hydroelectric system of claim 1, wherein the turbine is configured to rotate at speeds optimal for flow conditions and minimizing harm to aquatic organisms.

8. The hydroelectric system of claim 1, further comprising a regulator that maintains the high pressure fluid at a constant flow and pressure such that the generator is operated at a substantially constant rate.

9. The hydroelectric system of claim 1, wherein the piping of the circuit includes at least a portion directed upstream of a low dam to disrupt calm water.

10. The hydroelectric system of claim 1, further comprising a plurality of modules associated with the fluid circuit.

11. The hydroelectric system of claim 10, wherein the plurality of modules are arranged in series such that the plurality of modules in series is substantially perpendicular to the flow of water.

12. A method for operating a hydroelectric system comprising:
providing a hydroelectric system including;
(a) a module including;
(i) a protective housing having a first height and a first width, wherein the first width of the protective housing is greater than the first height of the protective housing;
(ii) a turbine housing retained within the protective housing, the turbine housing having a second height and a second width, wherein the second width of the turbine housing is greater than the second height of the turbine housing;
(iii) a turbine retained at least partially within the turbine housing, the turbine including a plurality of blades coupled with a substantially horizontal central shaft, wherein the substantially horizontal central shaft of the turbine has an axis of rotation that is substantially perpendicular to the fluid flow direction during operation; and
(iv) a fluid pump, the fluid pump being coupled with the substantially horizontal central shaft, wherein the fluid pump is configured to pump a high pressure fluid;
(b) a fluid circuit, the fluid circuit including piping, wherein the high pressure fluid is retained within the piping; and
(c) a generator, the generator being spaced apart a distance from the module and operably coupled with the fluid circuit, wherein the generator is driven by the high pressure fluid that is pumped by the fluid pump in response to the rotation of the turbine;
positioning the module adjacent a low head dam such that the module is substantially parallel to the low head dam, wherein a fluid is flowing over the low head dam;
rotating the turbine with the fluid flowing over the low dam, wherein the turbine is substantially perpendicular to the flow of the fluid;
pumping the high pressure fluid with the fluid pump in response to the rotation of the turbine; and
driving the generator with the high pressure fluid to produce electricity.

13. The method of claim 12, further comprising the step of pivoting the turbine housing relative to the protective housing such that flow of the fluid through the module is optimized.

14. The method of claim 12, further comprising a plurality of modules associated with the fluid circuit.

15. The method of claim 12, wherein the step of rotating the turbine comprises rotating the turbine at less than fifty revolutions per minute.

16. The method of claim 12, wherein the fluid circuit includes a regulator that maintains the high pressure fluid at a constant flow and pressure such that the generator is operated at a substantially constant rate.

17. A hydroelectric system for a low head dam comprising:
(a) a module including;
(i) a protective housing having a first height and a first width, wherein the protective housing includes an upstream Coanda-effect screen;
(ii) a turbine housing retained within the protective housing, the turbine housing having a second height and a second width, wherein the second width of the turbine housing is greater than the second height of the turbine housing;
(iii) a turbine retained at least partially within the turbine housing, the turbine including a plurality of blades coupled with a substantially horizontal central shaft, wherein the substantially horizontal central shaft of the turbine rotates in a direction substantially perpendicular to the flow of fluid during operation;
(iv) a fluid pump, the fluid pump being coupled with the substantially horizontal central shaft, wherein the fluid pump is configured to pump a high pressure fluid;
(v) a mounting platform, wherein the protective housing is detachably coupled with the mounting platform; and
(vi) at least one mounting point coupled with the mounting platform, wherein the at least one mounting point selectively couples the module adjacent a low head dam such that the module can be easily attached and removed;
(b) a fluid circuit, the fluid circuit including piping, wherein the high pressure fluid is retained within the piping; and
(c) at least one generator, the at least one generators being spaced apart a distance from the module and being operably coupled with the fluid circuit, wherein the generator is driven by the high pressure fluid that is pumped by the fluid pump in response to the rotation of the turbine.

18. The hydroelectric system of claim 17, wherein the protective housing has a substantially horizontal aperture such that fluid can enter the protective housing and the turbine housing retained therein.

19. The hydroelectric system of claim 17, wherein the turbine housing is pivotable relative to the protective housing.

20. The hydroelectric system of claim 17, further comprising a Tyrolean screen upstream of the protective housing.
